(19) United States
(12) Patent Application Publication
(10) Pub. No.: US 2021/0168621 A1
(43) Pub. Date: Jun. 3, 2021

(54) DYNAMIC PORT ALLOCATION FOR NG-RAN CONTROL PLANE INTERFACES

(71) Applicants: Jaemin Han, PORTLAND, OR (US); Alexander Sirotkin, Tel-Aviv (IL)

(72) Inventors: Jaemin Han, PORTLAND, OR (US); Alexander Sirotkin, Tel-Aviv (IL)

(21) Appl. No.: 17/174,709

(22) Filed: Feb. 12, 2021

Related U.S. Application Data
(60) Provisional application No. 62/976,765, filed on Feb. 14, 2020.
(60) Provisional application No. 63/007,253, filed on Apr. 8, 2020.

(51) Int. Cl. H04W 16/14; H04W 24/08; H04W 4/50; H04L 29/12; H04W 8/02; H04L 12/24

(52) U.S. Cl. CPC H04W 16/14; H04W 24/08; H04L 41/0806; H04L 61/1511; H04W 8/02; H04W 4/50

(57) ABSTRACT

An apparatus for use in a RAN network node includes processing circuitry coupled to a memory. To configure the RAN network node for dynamic port allocation in a wireless network, the processing circuitry is to decode port information received from an Operation, Administration, and Maintenance (OAM) node of the wireless network. The processing circuitry is further to assign a port number to a control interface of the RAN network node using the port information from the OAM node.

### PRIORITY CLAIM

This application claims the benefit of priority under 35 U.S.C. 119(e) to the following United States Provisional Patent Applications:

U.S. Provisional Patent Application Ser. No. 62/976,765, filed Feb. 14, 2020, and entitled “DYNAMIC PORT ALLOCATION FOR NG-RAN CONTROL PLANE INTERFACES;” and

U.S. Provisional Patent Application Ser. No. 63/007,253, filed Apr. 8, 2020, and entitled “DYNAMIC PORT ALLOCATION FOR NG-RAN CONTROL PLANE INTERFACES.”

Each of the above-listed provisional patent applications is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks such as 5G NR unlicensed spectrum (NR-U) networks. Other aspects are directed to systems and methods for dynamic port allocation for NG-RAN control plane interfaces.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE systems in the licensed, as well as unlicensed spectrum, is expected in future releases and 5G systems. Such enhanced operations can include techniques for dynamic port allocation for NG-RAN control plane interfaces.

### BRIEF DESCRIPTION OF THE FIGURES

In the figures, which are not necessarily drawn to scale, like numerals may describe similar components indifferent views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2 illustrates a block diagram of a communication device such as an evolved Node-B (eNB), a new generation Node-B (gNB), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

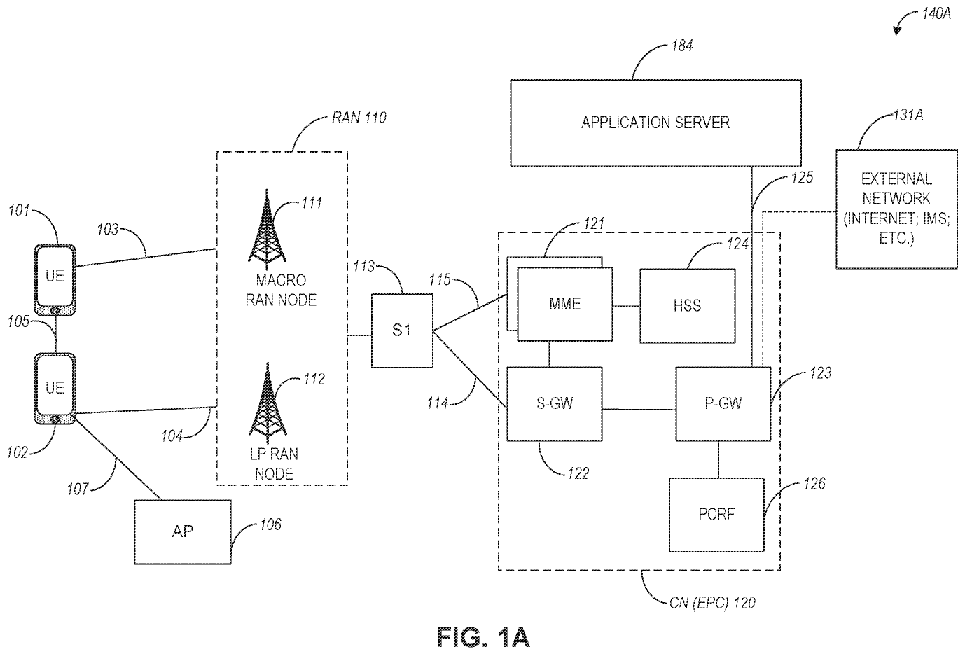

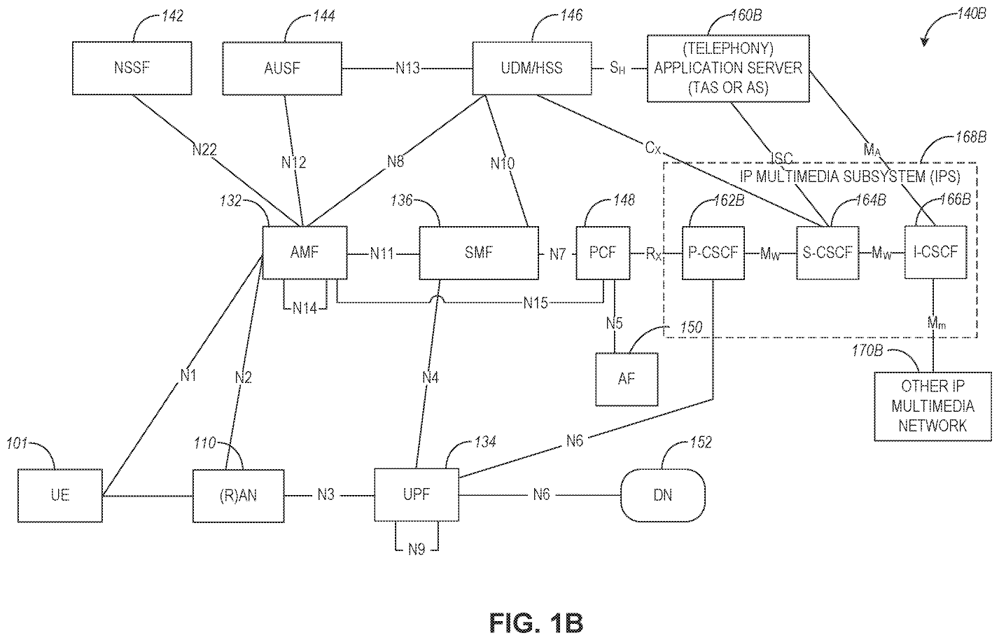

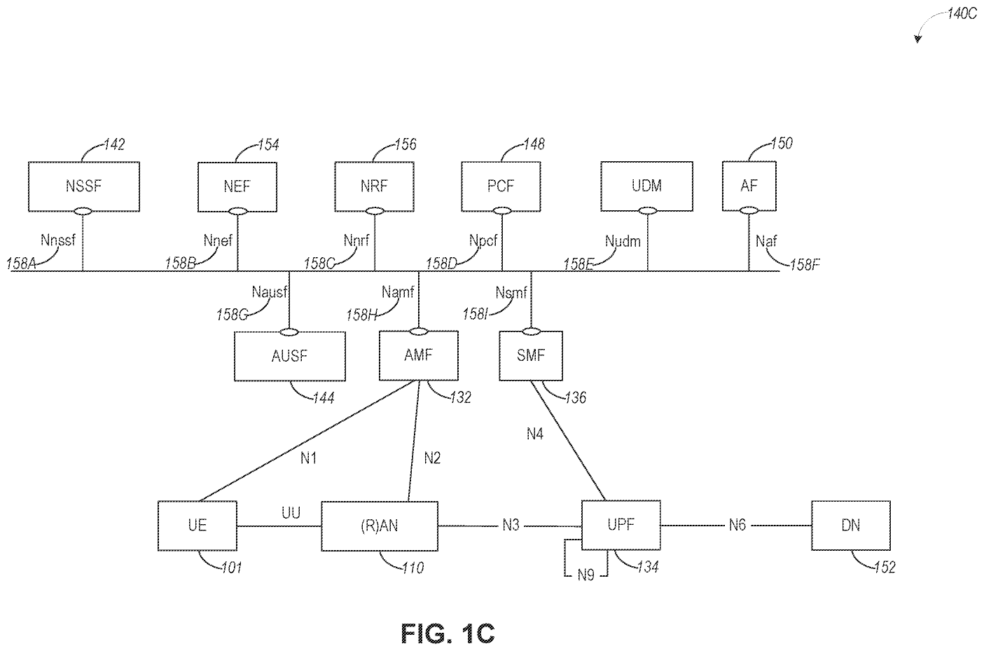

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs). NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services. Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134). N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In example embodiments, any of the UEs or RAN network nodes discussed in connection with FIG. 1A-FIG. 1C can be configured to operate using the techniques discussed herein associated with dynamic port allocation for NG-RAN control plane interfaces.

In some aspects, well-known port numbers for all control plane interfaces (e.g. NG, Xn, F1, etc) may be allocated by the Internet Assigned Numbers Authority (IANA). As port numbers are a scarce resource, it has become increasingly difficult to get new ports from TANA, especially based on requests to allocate a well-known port number for the W1 control interface (used in a split eNB architecture).

Disclosed techniques may be used for obtaining port numbers such as port numbers for NG-RAN interfaces. In the disclosed aspects, the W1 interface is used as an example, but the disclosure is not limited in this regard and the disclosed techniques can be used on all other (existing and to-be-defined) network interfaces, (e.g., Xn, F1, E1, X2, etc.).

In some embodiments, Stream Control Transmission Protocol (SCTP) is used as the transport protocol for W1-Control Plane (W1-C) interface. If a well-known port number (e.g., as assigned by IANA) is to be used, the ng-eNB Distributed Unit (ng-eNB-DU) would establish an SCTP connection to the well-known port number in ng-eNB-CU. After that, a W1-AP initialization procedure (i.e., W1 SETUP REQUEST) would take place. In the absence of the well-known port number, consideration may be to ensure that both ng-eNB-DU and ng-eNB-CU know on which port number the ng-eNB-DU would attempt to establish the SCTP connection. The following embodiments may be used for configuring port numbers for interfaces.

### Embodiment 1—Using Operation, Administration, and Maintenance (OAM) Node

In some aspects, any port number can be used as the destination port number for the W1-C SCTP connection establishment. In some embodiments, before the W1-C connection establishment, the OAM node configures the port number to be used for W1 in both the ng-eNB-DU and the ng-eNB-CU.

In some aspects, both network nodes on both sides of the interface may be controlled by the same OAM node. While in the case of W1 it is likely to be the case, a single OAM node arrangement may not be assumed in all cases. For example, oftentimes NG-RAN and 5G Core network (5GC) are controlled by different OAM nodes (often from different vendors) and therefore this option would incur additional manual configuration burden.

### Embodiment 2—Using a Domain Name System (DNS) Server

In some aspects, DNS discovery may be used in the core network (both EPC and 5GC) and NG-RAN.

This embodiment relies on procedures for DNS-based service discovery as defined in IETF RFC 6763, which specifies how DNS can be used for service discovery.

In some aspects, DNS service (SRV) record (as defined in IETF RFC 2782) can be used to define service for port number assignment using the following structure “<Instance>.<Service>.<Domain>”. For example, the W1-C “service record” can be defined as follows: “3gpp-w1.sctp.operator.com”. That is, the “domain” part is “operator.com” which can be a name of the operator deploying the NG-RAN, the “service” part can be “sctp” as SCTP is used as the transport protocol for W1, and the “instance” part can be “3gpp-w” indicating that the record carries the information (e.g., one or more port numbers) to be used for W interface establishment.

In some aspects, the SRV record defined for W1 would contain, among other information, the following:

(a) port: the port on which the W1 interface connection should be established; and

(b) target: the hostname of the hosting module (e.g., ng-eNB-CU).

An advantage of the DNS based discovery is the flexibility (once implemented and deployed, it would allow the usage of any port for W1 (or other) interfaces). Furthermore, it would be easy to maintain and update that information, e.g. when new network nodes are added. However, this embodiment is associated with the deployment of a new service such as DNS in NG-RAN.

### Embodiment 3—Via Another 3GPP Interface

This embodiment relies on two assumptions, both of which would require changes in RAN3 specification:

(a) The port number of an interface (e.g., W1) is known at some centralized node (e.g., an AMF node). Furthermore, it may be possible to configure (e.g., in the AMF) different port numbers for different network nodes (either specific nodes or nodes from a specific vendor or of a specific version).

(b) The network node establishing the (e.g., W1) interface is the one connected to the centralized node. That is, the procedure of W1 interface establishment (which is currently triggered by the ng-eNB-DU) may be modified so that it is the ng-eNB-CU that would establish a new interface.

In some embodiments, when a new ng-eNB-DU is introduced in the network, the information about which port it uses for the W1 interface (or any other interface) establishment is configured in a centralized node, e.g. at the AMF. The configuration can be: per network node instance, per network node version, or network node vendor.

In some aspects, the ng-eNB-CU would inquire (e.g., periodically) the AMF about new ng-eNB-DU nodes introduced in the network and their configuration, e.g., the W1 port number. Alternatively, the AMF may “push” that information to the ng-eNB-CU (e.g., using AMF CONFIGURATION UPDATE procedure). Once the ng-eNB-CU knows the address and the port number of the newly introduced ng-eNB-DU node, it would establish the W1 connection to that address and port.

### Embodiment 4—Using a“Local” Port Number

This embodiment may be considered as a “violation” of port usage principles. However, it is still a feasible solution because, unlike the Internet, NG-RAN is a closed network fully controlled by an operator. Therefore, it may be possible to assume that all the applications and services running on that network use either well-known ports, dynamic ports, or ports configured by the operator.

With this understanding, it may be possible to designate a certain “unused” (or rarely used in practice) port number of the W1 interface, which would then be known to both ng-eNB-CU and ng-eNB-DU as the destination port for W1 connection establishment.

### Embodiment 5—Using a Private Port Range

This is a variant of Embodiment 4, with the main difference being is that a certain range of ports can be assigned by IANA for use in private intranets, in a way analogous to how 10.0.0.0/8 and 192.168.0.0/16 IP address ranges are assigned.

In some aspects, port numbers in the “private range” can be self-assigned to a specific application by an organization running a private intranet (in the same way as private IP addresses are assigned). Within that private intranet, the self-assigned port number can be considered unique and well-known within the limits of that private intranet, in the sense that all applications in that intranet can assume that only the self-assigned service can run on that port.

In some aspects, a different organization may decide to self-allocate ports in the private range differently. There is no interoperability problem because services running on different private intranets do not communicate with each other.

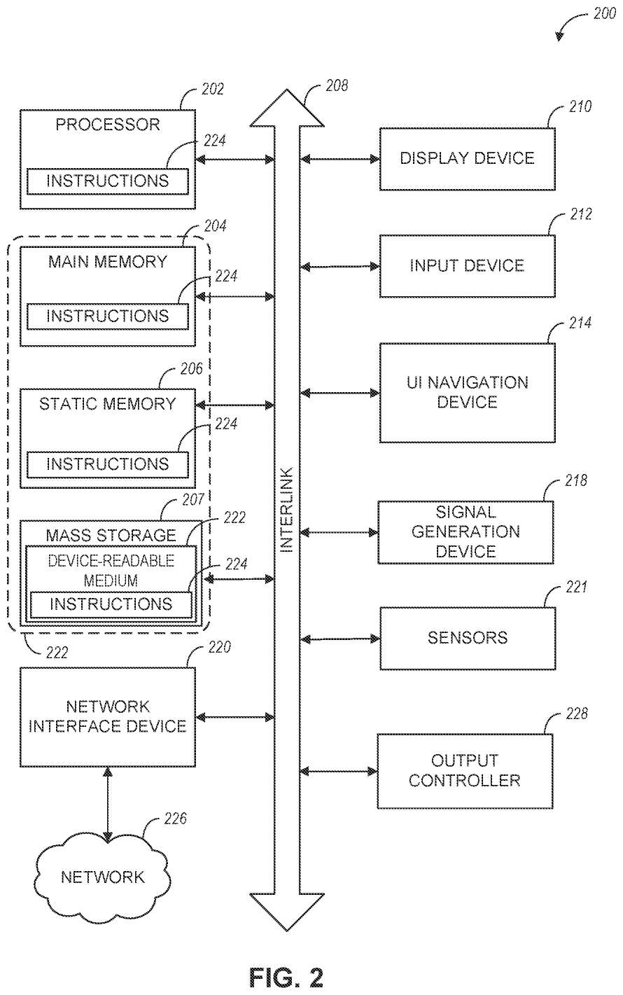

FIG. 2 illustrates a block diagram of a communication device such as an evolved Node-B (eNB), a next generation Node-B (gNB), an access point (AP), a wireless station (STA), a mobile station (MS), or a user equipment (UE), in accordance with some aspects and to perform one or more of the techniques disclosed herein. In alternative aspects, the communication device 200 may operate as a standalone device or may be connected (e.g., networked) to other communication devices.

Circuitry (e.g., processing circuitry) is a collection of circuits implemented in tangible entities of the device 200 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 200 follow.

In some aspects, the device 200 may operate as a standalone device or may be connected (e.g., networked) to other devices. In a networked deployment, the communication device 200 may operate in the capacity of a server communication device, a client communication device, or both in server-client network environments. In an example, the communication device 200 may act as a peer communication device in a peer-to-peer (P2P) (or other distributed) network environment. The communication device 200 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 200 may include a hardware processor 202 (e.g., a central processing unit (CPU), a graphics processing unit (GPU), a hardware processor core, or any combination thereof), a main memory 204, a static memory 206, and mass storage 207 (e.g., hard drive, tape drive, flash storage, or other block or storage devices), some or all of which may communicate with each other via an interlink (e.g., bus) 208.

The communication device 200 may further include a display device 210, an alphanumeric input device 212 (e.g., a keyboard), and a user interface (UI) navigation device 214 (e.g., a mouse). In an example, the display device 210, input device 212, and UI navigation device 214 may be a touchscreen display. The communication device 200 may additionally include a signal generation device 218 (e.g., a speaker), a network interface device 220, and one or more sensors 221, such as a global positioning system (GPS) sensor, compass, accelerometer, or another sensor. The communication device 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 207 may include a communication device-readable medium 222, on which is stored one or more sets of data structures or instructions 224 (e.g., software) embodying or utilized by any one or more of the techniques or functions described herein. In some aspects, registers of the processor 202, the main memory 204, the static memory 206, and/or the mass storage 207 may be, or include (completely or at least partially), the device-readable medium 222, on which is stored the one or more sets of data structures or instructions 224, embodying or utilized by any one or more of the techniques or functions described herein. In an example, one or any combination of the hardware processor 202, the main memory 204, the static memory 206, or the mass storage 216 may constitute the device-readable medium 222.

As used herein, the term “device-readable medium” is interchangeable with “computer-readable medium” or “machine-readable medium”. While the communication device-readable medium 222 is illustrated as a single medium, the term “communication device-readable medium” may include a single medium or multiple media (e.g., a centralized or distributed database, and/or associated caches and servers) configured to store the one or more instructions 224. The term “communication device-readable medium” is inclusive of the terms “machine-readable medium” or “computer-readable medium”, and may include any medium that is capable of storing, encoding, or carrying instructions (e.g., instructions 224) for execution by the communication device 200 and that cause the communication device 200 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 224 may further be transmitted or received over a communications network 226 using a transmission medium via the network interface device 220 utilizing any one of a number of transfer protocols. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input-multiple-output (SIMO), MIMO, or multiple-input-single-output (MISO) techniques. In some examples, the network interface device 220 may wirelessly communicate using Multiple User MIMO techniques.

The term “transmission medium” shall be taken to include any intangible medium that is capable of storing, encoding, or carrying instructions for execution by the communication device 200, and includes digital or analog communications signals or another intangible medium to facilitate communication of such software. In this regard, a transmission medium in the context of this disclosure is a device-readable medium.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus to be used in a RAN network node, the apparatus comprising:
processing circuitry, wherein to configure the RAN network node for dynamic port allocation in a wireless network, the processing circuitry is to:
decode port information received from an Operation, Administration, and Maintenance (OAM) node of the wireless network; and
assign a port number to a control interface of the RAN network node using the port information from the OAM node; and
a memory coupled to the processing circuitry and configured to store the port information.

2. The apparatus of claim 1, wherein the RAN network node comprises a Centralized Unit (CU) and a Distributed Unit (DU), and wherein the processing circuitry is to:
decode the port information to obtain the port number and a hostname, the hostname identifying the CU or the DU of the RAN network node.

3. The apparatus of claim 2, wherein the control interface of the RAN network node is a W1-C control interface or an F1-C control interface.

4. The apparatus of claim 2, wherein the hostname identifies the CU and the port number is a destination port number associated with the CU.

5. The apparatus of claim 4, wherein the processing circuitry is to:
decode the port information to further obtain a second hostname identifying the DU and a second port number, the second port number configured as a destination port number associated with the DU.

6. The apparatus of claim 5, wherein the processing circuitry is to:
encode using a Stream Control Transmission Protocol (SCTP), data for transmission on the control interface between the CU and the DU based on the destination port number associated with the CU or the destination port number associated with the DU.

7. The apparatus of claim 1, wherein the processing circuitry is to:
encode a request for a service (SRV) record for transmission to a Domain Name System (DNS) Server of the wireless network; and
decode the SRV record received from the DNS server in response to the request, the SRV record including configuration information associated with a second control interface of the RAN network node.

8. The apparatus of claim 7, wherein the configuration information in the SRV record identifies the second control interface, a communication protocol for use when communicating data on the second control interface, and a destination port number for the second control interface.

9. The apparatus of claim 1, wherein the processing circuitry is to:
decode second port information received from an Access and Mobility Management Function (AMF) node of the wireless network; and
assign a second port number to a second control interface of the RAN network node using the second port information.

10. The apparatus of claim 1, wherein the control interface is between a Centralized Unit (CU) and a Distributed Unit (DU) of the RAN network node, and the processing circuitry is to:
detect an unused port number associated with the RAN network node; and
assign the unused port number to the control interface between the CU and the DU of the RAN network node.

11. The apparatus of claim 1, further comprising transceiver circuitry coupled to the processing circuitry; and, one or more antennas coupled to the transceiver circuitry.

12. A non-transitory computer-readable storage medium that stores instructions for execution by one or more processors of a RAN network node, the instructions to configure the RAN network node for dynamic port allocation in a wireless network, and to cause the RAN network node to perform operations comprising:
decoding port information received from an Operation, Administration, and Maintenance (OAM) node of the wireless network; and
assigning a port number to a control interface of the RAN network node using the port information.

13. The computer-readable storage medium of claim 12, wherein the RAN network node comprises a Centralized Unit (CU) and a Distributed Unit (DU), and wherein executing the instructions further causes the RAN network node to perform operations comprising:
decoding the port information to obtain the port number and a hostname, the hostname identifying the CU or the DU of the RAN network node.

14. The computer-readable storage medium of claim 13, wherein the control interface of the RAN network node is a W1-C control interface or an F1-C control interface.

15. The computer-readable storage medium of claim 13, wherein the hostname identifies the CU and the port number is a destination port number associated with the CU.

16. The computer-readable storage medium of claim 15, wherein executing the instructions further causes the RAN network node to perform operations comprising:
decoding the port information to further obtain a second hostname identifying the DU and a second port number, the second port number configured as a destination port number associated with the DU.

17. The computer-readable storage medium of claim 16, wherein executing the instructions further causes the RAN network node to perform operations comprising:
encoding using a Stream Control Transmission Protocol (SCTP), data for transmission on the control interface between the CU and the DU based on the destination port number associated with the CU or the destination port number associated with the DU.

18. A non-transitory computer-readable storage medium that stores instructions for execution by one or more processors of a RAN network node, the instructions to configure the RAN network node for dynamic port allocation in a wireless network, and to cause the RAN network node to perform operations comprising:
decoding port information received from an Operation, Administration, and Maintenance (OAM) node of the wireless network;
assigning a port number to a control interface of the RAN network node using the port information from the OAM node;
encoding a request for a service (SRV) record for transmission to a Domain Name System (DNS) server of the wireless network; and
decoding the SRV record received from the DNS server in response to the request, the SRV record including configuration information associated with a second control interface of the RAN network node.

19. The computer-readable storage medium of claim 18, wherein the configuration information in the SRV record identifies the second control interface, a communication protocol for use when communicating data on the second control interface, and a destination port number for the second control interface.

20. The computer-readable storage medium of claim 18, wherein executing the instructions further causes the RAN network node to perform operations comprising:
decoding port information received from an Access and Mobility Management Function (AMF) node of the wireless network; and
assigning a destination port number to a third control interface of the RAN network node using the port information from the AMF node.
